(19) United States
(12) Patent Application Publication
(10) Pub. No.: US 2017/0153266 A1
(43) Pub. Date: Jun. 1, 2017

(54) SYSTEMS AND METHODS FOR DETERMINING INERTIAL PARAMETERS USING INTEGRATION

(71) Applicant: Lumedyne Technologies Incorporated, San Diego, CA (US)

(72) Inventor: Ricardo Emilio Dao, San Diego, CA (US)

(21) Appl. No.: 14/954,749

(22) Filed: Nov. 30, 2015

(51) Int. Cl. G01P 15/125; G01C 19/5726; G01C 19/5733

(52) U.S. Cl. CPC G01P 15/125; G01C 19/5733; G01C 19/5726

(57) ABSTRACT

System and methods are disclosed herein for integrating to determine inertial parameters. A resonator produces an input pulse stream based on the inertial parameter. A window circuit selects a portion of the input pulse stream. An exclusive-or circuit uses an exclusive-or operation to combine the selected portion with a reference pulse stream to produce a combined pulse stream. A counter increments a count based on the combined pulse stream. A multiplier circuit scales the incremented count to produce an output signal corresponding to the inertial parameter.

### FIELD OF THE INVENTION

In general, this disclosure relates to inertial sensors used to sense external perturbations such as acceleration and rotation. The inertial sensors are at scales ranging from microelectromechanical systems (MEMS) at the microscale, to mesoscale sensors, to large scale sensors.

### BACKGROUND

A linear sensor measures an external perturbation by producing a system output that varies linearly with the external perturbation. A fixed scale factor can be used to describe the linear relationship between the external perturbation and the sensor output. The system output of the linear sensor can also include a fixed offset. However, both the scale factor and offset of the linear sensor can change over time due to many factors. These factors include changes in mechanical compliance due to temperature, long-term mechanical creep, changes in packaging pressure of sensors due to imperfect seals or internal outgassing, changes in quality factors of resonators, drift of one or more amplifier gain stages, capacitive charging effects, drift on bias voltages applied to the sensor, drift on any internal voltage reference required in a signal path, drift of input offset voltages, drift of any required demodulation phase and gain, and the like. In linear sensors, changes in the scale factor or the offset will result in changes in the system output, even if the external perturbation is not changed. This causes accuracy of linear sensors to degrade over time.

Controlling drift of sensor system output is important in many applications, especially those requiring performance at low frequencies. Low frequency, or 1/f, noise reduces low frequency performance. High levels of 1/f noise limit a sensor's ability to measure low frequency signals that may be masked by the 1/f noise. For example, navigation systems require good low-frequency performance with low 1/f noise and low drift. Because many useful navigation signals appear in the low frequency end of the spectrum, these must be accurately measured to compute position.

### SUMMARY

Accordingly, systems and methods are described herein for integrating to determine inertial parameters. An inertial sensor for determining an inertial parameter includes a window circuit that is configured for receiving an input pulse stream based on an inertial parameter. The window circuit is configured for selecting a portion of the input pulse stream. The inertial sensor includes an exclusive-or circuit configured for combining, using an exclusive-or operation, the selected portion with a reference pulse stream to produce a combined pulse stream. The inertial sensor also includes a counter circuit configured for incrementing a count based on the combined pulse stream. The inertial sensor also includes a scaling circuit configured for scaling the incremented count to produce an output signal corresponding to the inertial parameter.

In some examples, the inertial sensor includes a resonator configured for producing the input pulse stream. In some examples, the window circuit is configured to receive the input pulse stream from a second inertial sensor. The second inertial sensor can be located on the same substrate as the inertial sensor. In some examples, the inertial sensor is located on a different substrate.

In some examples, the inertial sensor also includes a drive sense capacitor configured for producing a drive sense capacitance proportional to a position of an oscillating mass of the resonator. The inertial sensor can also include a drive adjustment loop configured for adjusting a drive voltage based on the drive sense capacitance. The window circuit can be configured for selecting an initial time of the selected portion based on a change in the drive sense capacitance. The selected portion can exclude a pulse edge corresponding to a reversal of direction of the oscillating mass.

In some examples, the inertial sensor also includes an adjustment counter circuit configured for counting pulses of the selected portion to produce an amplitude adjustment signal. The inertial sensor can also include a clock adjustment circuit configured for adjusting, based on the drive sense capacitance, a period of a clock signal. The clock adjustment circuit can be configured for adjusting, based on the amplitude adjustment signal, the period of the clock signal to produce an adjusted clock signal. Because the frequency of the clock signal is the inverse of the period of the clock signal, adjusting the period of the clock signal by definition adjusts the frequency of the clock signal.

In some examples, the inertial sensor also includes a memory configured for storing a stored pulse stream. The inertial sensor can include a pulse generator circuit configured for adjusting the stored pulse stream based on the adjusted clock signal to produce the reference pulse stream.

In some examples, the inertial sensor can include a summing circuit configured for subtracting the reference pulse stream from the selected portion to produce a polarized pulse stream. The inertial sensor can include a sign detection circuit configured for producing a polarity signal based on the polarized pulse stream. The scaling circuit can scale the incremented count by multiplying by the polarity signal.

In some examples, the resonator can include an oscillating mass. The resonator can also include a capacitor configured for producing a capacitance and an extremum in the capacitance when the oscillating mass is in an aligned position. The resonator can also include an analog front end circuit configured for producing the input pulse stream based on the capacitance. In some examples, the input pulse stream can be a digital signal.

In some examples, the inertial parameter can be an acceleration of the inertial sensor. In other examples, the inertial sensor can be a gyroscope and the inertial parameter can be a velocity of a vibrating mass of the gyroscope.

### BRIEF DESCRIPTION OF THE DRAWINGS

The above and other features of the present disclosure, including its nature and its various advantages, will be more apparent upon consideration of the following detailed description, taken in conjunction with the accompanying drawings in which:

FIG. 1 depicts a system for integrating a pulse stream to measure an inertial parameter of an inertial sensor;

FIG. 2 depicts a graph illustrating various signals of the system depicted in FIG. 1, with the right-hand column focusing on a time interval during which an input inertial parameter is zero;

FIG. 3 depicts a graph representing various signals of the system depicted in FIG. 1, with the right-hand column focusing on a time interval during which a small acceleration exists;

FIG. 4 depicts a graph representing various signals of the system depicted in FIG. 1, with the right-hand column focusing on a time interval during which an input inertial parameter has a larger magnitude than during the time interval depicted in FIG. 3;

FIG. 5 depicts a graph representing various signals of the system depicted in FIG. 1, with the right-hand column focusing on a time interval during which the input inertial parameter has a non-zero magnitude and a negative polarity;

FIG. 6 depicts a graph representing various signals of the system depicted in FIG. 1, with the right-hand column focusing on a time interval during which the input inertial parameter has a non-zero magnitude and a positive polarity;

FIG. 7 depicts a graph showing acceleration signals and a graph showing a frequency spectrum;

FIG. 8 depicts three views, each showing a schematic representation of parts of a movable element and a fixed element;

FIG. 9 depicts a planform view schematic of a MEMS subsystem;

FIG. 10 depicts a perspective view of the MEMS subsystem depicted in FIG. 9 undergoing oscillation and rotation;

FIG. 11 schematically depicts an exemplary process used to extract inertial information from an inertial sensor with periodic geometry;

FIG. 12 depicts a graph which represents the association of analog signals derived from an inertial sensor with zero-crossing times and displacements of the inertial sensor;

FIG. 13 depicts a graph showing the effects of an external perturbation on input and output signals of the inertial sensors described herein;

FIG. 14 depicts a graph that illustrates the response in the form of an electrical current to an oscillator displacement;

FIG. 15 depicts a graph showing a rectangular waveform and signal representing zero-crossing times of the current signal depicted in FIG. 14;

FIG. 16 is a graph which illustrates additional time intervals of the displacement curve depicted in FIG. 14;

FIG. 17 depicts the relationship between capacitance of the inertial sensor depicted in FIG. 11 and displacement of the movable element depicted in FIG. 8;

FIG. 18 depicts the relationship between displacement and the first derivative of capacitance with respect to displacement.

FIG. 19 depicts the relationship between displacement and the second derivative of capacitance with respect to displacement;

FIG. 20 depicts the relationship between time, the rate of change of capacitive current, and displacement;

FIG. 21 depicts a flow chart of a method for integrating to determine inertial parameters.

### DETAILED DESCRIPTION

To provide an overall understanding of the disclosure, certain illustrative implementations will now be described, including systems and methods for integrating to determine inertial parameters.

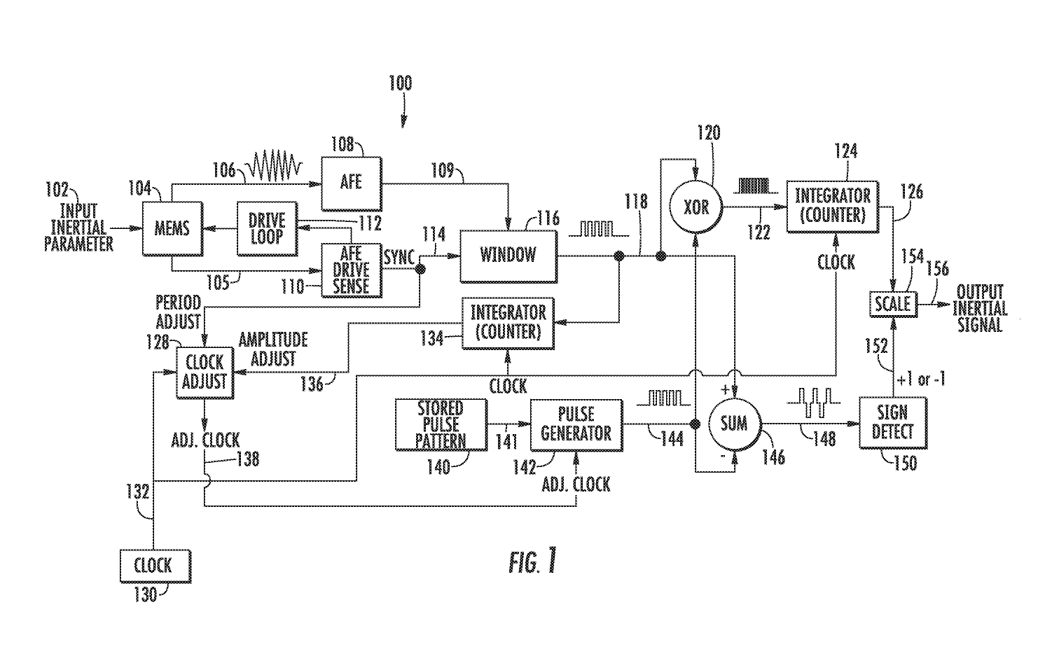

FIG. 1 depicts a system 100 for integrating a pulse stream to measure an inertial parameter 102 of an inertial sensor. Some examples of the inertial parameter include an acceleration of the inertial sensor, a rotation of the inertial sensor, and a velocity of a vibrating mass of the inertial sensor. The inertial sensor includes a MEMS component 104 that is perturbed by the inertial parameter 102. For example, if the inertial parameter 102 is an acceleration, the MEMS component 104 is perturbed by the acceleration. Likewise, if the inertial parameter is a rotation, the MEMS component 104 is perturbed by the rotation. Likewise, if the inertial parameter 102 is a vibrating mass velocity, the MEMS component 104, or a portion of the MEMS component 104 such as a vibrating mass, moves at the vibrating mass velocity. In response to the inertial parameter 102, the MEMS component 104 produces a MEMS output signal 106. The MEMS output signal 106 is an analog signal, and in some examples, can contain one or more frequency components. An analog front end (AFE) circuit 108 receives the MEMS output signal 106 and produces a digital pulse stream 109. The AFE circuit 108 can include one or more of a transimpedance amplifier (TIA) and a charge amplifier (CA).

The digital pulse stream 109 contains pulses corresponding to times of zero-crossings of the MEMS output signal 106. A window circuit 116 receives the digital pulse stream 109 and selects a selected portion 118 of the digital pulse stream 109 for further analysis. In some examples, the window circuit 116 is configured to multiply the digital pulse stream 109 by a rectangular wave having a minimum value of zero and a maximum value of one. In these examples, the window circuit 116 selects the selected portion 118 by multiplying by one at selected times and multiplying by zero at non-selected times. This selection can comprise application of a time mask window. The window circuit 116 can perform selection to exclude portions of the digital pulse stream 109 corresponding to times at which an oscillator of the MEMS component 104 reverses direction. These reversal times produce zero-crossings, or pulse edges, in the digital pulse stream 109 which are dependent on oscillator frequency and amplitude, while the other zero-crossings, or pulse edges, in the digital pulse stream 109 are primarily dependent on oscillator position. The window circuit 116 receives the sync signal 114 from the AFE drive sense circuit 110. The window circuit 116 is configured to select an initial time of the selected portion 118 with an edge, either rising or falling, of the sync signal 114. In this way, the window circuit 116 synchronizes the beginning of the selected portion 118 with the movement of the oscillator of the MEMS component 104.

The MEMS component 104 produces a drive sense signal 105 that is detected by a drive sense AFE 110. The drive sense signal 105 can be a capacitance, a current, or a charge. In some examples, the drive sense signal 105 can be based on a drive voltage used to drive an oscillating mass of the MEMS component 104. In some examples, the drive sense signal 105 is produced by a drive sense capacitor and is proportional to a position of the oscillator of the MEMS component 104. The drive sense AFE 110 produces a digital sync signal 114 based on the drive sense signal 105. The sync signal 114 contains information corresponding to a frequency and a phase of the drive voltage. In some examples, the sync signal 114 contains one rising edge and one falling edge for each oscillation of the oscillating mass of the MEMS component 104. In some examples, the sync signal 114 contains a predetermined number of rising edges and falling edges for each oscillation of the oscillating mass, and the predetermined number of rising edges and falling edges can be different than one. Thus, the sync signal 114 can be used to index other signals to motion of the oscillating mass.

The drive sense AFE 110 also outputs a signal to a drive adjustment loop circuit 112. The drive adjustment loop circuit 112 is configured for performing closed-loop control of the motion of the oscillating mass. The drive adjustment loop circuit 112 can be configured to control one or more of the amplitude, frequency, and phase of the motion of the oscillating mass based on one or more signals provided by the drive sense AFE 110. The drive adjustment loop circuit 112 can adjust the motion of the oscillating mass by adjusting one or more of an amplitude, frequency, and phase of the drive voltage. In this way, the motion of the oscillating mass can be tightly regulated.

The system 100 contains a memory circuit 140 configured to store a stored pulse stream 141. In some examples, the stored pulse stream 141 can be captured from the selected portion 118 during a time at which no external disturbances exist and the input inertial parameter 102 is zero (or a known value, such as 1 g). After capturing the stored pulse stream 141, the stored pulse stream 141 can be stored in the memory circuit 140. In some examples, the stored pulse stream 141 is captured during recalibration. A pulse generator 142 receives the stored pulse stream 141 from the memory circuit 140 and produces a reference pulse stream 144 based on the stored pulse stream 141.

An exclusive-or (XOR) circuit 120 receives the reference pulse stream 144 and the selected portion 118. The XOR circuit 120 combines, in an XOR operation, the selected portion 118 and the reference pulse stream 144 to produce a combined pulse stream 122. A counter circuit 124 receives the combined pulse stream 122 and also receives a clock signal 132 from a clock circuit 130. The counter circuit 124 can be an integrator. Using the clock signal 132, the counter circuit 124 integrates the combined pulse stream 122. In some examples, the counter circuit 124 performs this integration by incrementing a count for each clock cycle corresponding to a predetermined value of the combined pulse stream 122. For example, if the predetermined value is a high value, the counter circuit 124 increments the count for each clock cycle at which the combined pulse stream 122 has a high value. The counter circuit 124 can increment analogously if the predetermined value is a low value. The counter circuit 124 continues to conditionally increment the count in this way for a predetermined number of clock cycles. For example, the predetermined number of clock cycles can correspond to one or more periods of the motion of the oscillating mass. After reaching the predetermined number of clock cycles, the counter circuit 124 produces an incremented count signal 126. The predetermined number of clock cycles can be decreased to increase the bandwidth of the inertial sensor, or increased to improve the resolution of the inertial sensor.

The combined pulse stream 122 reflects the magnitude of the difference between the selected portion 118 and the reference pulse stream 144. If the combined pulse stream 118 is an identical signal to the reference pulse stream 144, the combined pulse stream 122 is a signal that never deviates from zero, or an alternative low value. However, if the phase of the selected portion 118 is different from the phase of the reference pulse stream 144, the combined pulse stream 122 contains non-zero values, or alternative high values. The phase of the selected portion 118 can either lead or lag the phase of the reference pulse stream 144. As the phases of the selected portion 118 and the reference pulse stream 144 increasingly diverge, the pulses of the combined pulse stream 122 increase in frequency and/or pulse width.

The system 100 includes a summing circuit 146 that is configured to subtract the reference pulse stream 144 from the selected portion 118 to produce a polarized pulse stream 148. This subtracting can comprise multiplying the reference pulse stream 144 by −1 and adding the result to the selected portion 118. The polarized pulse stream 148 provides an indication of whether the phase of the selected portion 118 leads or lags the phase of the reference pulse stream 144. The system 100 includes a sign detection circuit 150 configured to receive the polarized pulse stream 148 and produce a polarity signal 152 based on the direction of the inertial parameter 102. By determining whether a pulse occurring within a predetermined window of the polarized pulse stream 148 is positive or negative, the sign detection circuit 150 can determine the relative phase. For example, in a first predetermined window, if the first or only pulse of the polarized pulse stream 148 is positive, this indicates that the phase of the selected portion 118 leads the phase of the reference pulse stream 144. Conversely, if the first or only pulse within this first window is negative, this indicates that the phase of the selected portion 118 lags the phase of the reference pulse stream 144. For a second window at a second location within the polarized pulse stream 148, the indications may be reversed. In this example, if the first or only pulse in the second window of the polarized pulse stream 148 is positive, this indicates that the phase of the selected portion 118 lags the phase of the reference pulse stream 144. Conversely, if the first or only pulse in the second window is negative, this indicates that the phase of the selected portion 118 leads the phase of the reference pulse stream 144.

The phase of the selected portion 118 as compared to the phase of the reference pulse stream 144 can indicate a polarity of the inertial parameter 102. For example, an acceleration in a positive direction can cause the phase of the selected portion 118 to lead the phase of the reference pulse stream 144, while an acceleration in the negative direction can cause the phase of the selected portion 118 to lag the phase of the reference pulse stream 144. Likewise, a velocity in a first direction may cause the phase of the selected portion 118 to lead the phase of the reference pulse stream 144, while a velocity in the opposite direction can cause the phase of the selected portion 118 to lag the phase of the reference pulse stream 144. Because the reference pulse stream is based on a stored pulse stream, the phase of the reference pulse stream 144 is not affected by the inertial parameter 102. Thus, comparing the selected portion 118 to the reference pulse stream 144 provides indications of both the magnitude and the direction (or polarity) of the inertial parameter 102.

The sign detection circuit 150 is configured to output a value of +1 when the inertial parameter 102 is acting in a positive direction and to output a value of −1 when the inertial parameter 102 is acting in a negative direction. Thus, the sign detection circuit 150 is configured to determine the polarity of the input inertial parameter 102, and based on this determination, output the polarity signal 152 for appropriately polarizing an inertial output signal 156.

The system 100 includes a scaling circuit 154 configured to receive the incremented count 126 and the polarity signal 152. The scaling circuit 154 can be a multiplier circuit. The scaling circuit 154 is configured to multiply the integrated count 126 by the polarity signal 152, and in some examples, by an additional scaling factor. The scaling circuit is configured to output, based on this multiplication, the output inertial signal 156. The output inertial signal 156 is a measurement of the input inertial parameter 102. By multiplying the integrated count 126 by the polarity signal 152, the scaling circuit 154 accounts for the polarity of the input inertial parameter 102. In some examples, the scale factor scales the integrated count by one or more predetermined constants to produce a measurement of the inertial parameter 102. In some examples, the scale factor may comprise a polynomial to account for offsets and/or non-linearities. The scaling circuit 154 can scale the integrated count 126 by the polarity signal 152 either before or after applying the scale factor. By scaling by one or more predetermined constants, the scaling circuit can provide the output inertial signal 156 in appropriate units, such as g or SI, CGS, MKS, British Imperial, or U.S. Customary units for acceleration or velocity.

The system 100 includes a clock circuit 130 configured to produce a clock signal 132. The clock circuit 130 may be purely electronic, or, in some examples, may include one or more MEMS resonators. The clock circuit 130 provides the clock signal 132 to a clock adjustment circuit 128, an adjustment counter circuit 134, and the counter circuit 124. The clock adjustment circuit 128 then provides an adjusted clock signal 138 to the pulse generator circuit 142.

The adjustment counter circuit 134 integrates the selected portion 118 using the clock signal 132. The adjustment counter circuit 134 can be an integrator. The adjustment counter circuit 134 integrates the selected portion 118 by counting pulses of the selected portion 118. Based on the counted pulses, the adjustment counter circuit 134 outputs an amplitude adjustment signal 136. The amplitude adjustment signal 136 is proportional to the amplitude of the motion of the oscillating mass of the MEMS component 104.

The clock adjustment circuit 128 receives the sync signal 114 from the drive sense AFE 110. The clock adjustment circuit 128 uses the sync signal 114 to adjust for variations in the period or frequency of the motion of the oscillating mass of the MEMS component 104. The clock adjustment circuit 128 uses the amplitude adjustment signal 136 to adjust for variations in oscillation amplitude of the oscillating mass. These variations in frequency and amplitude of the oscillating mass can be caused by changes in temperature or other external factors affecting the motion, stiffness, and natural frequency of the MEMS component 104. While the input inertial parameter 102 also has an effect on the frequency, period, and amplitude of the oscillating mass, the effect is small compared to the effect of temperature. Thus, the clock adjustment circuit 128 can provide an adjusted clock signal 138 to account for variations in external factors such as temperature. The pulse generator circuit 142 uses the adjusted clock signal 138 to adjust the stored pulse stream 141. By adjusting the stored pulse stream 141 to account for variations in temperature, the reference pulse stream 144 is thus compensated for temperature fluctuations. This can be illustrated by considering a variation in oscillation amplitude of the oscillating mass, which can be caused by a variation in temperature. If the oscillation amplitude of the oscillating mass varies, the selected portion 118 will also vary. Thus, the adjustment counter circuit 134 will vary the output of the amplitude adjustment signal 136. Because the clock adjustment circuit varies the adjusted clock signal 138 based on variations in the amplitude adjustment signal 136, the reference pulse stream 144 will be compensated for variations in oscillation amplitude of the oscillating mass. By compensating the reference pulse stream 144 for temperature variations, the system 100 can make an accurate comparison between the selected portion 118 and the reference pulse stream 144 to measure the input inertial parameter 102.

The system 100 can be implemented with a combination of simple, low-power circuits such as memories, multiplier circuits, summing circuits, integrators, counters, and logic gates. Implementing the system 100 with these types of circuits results in high speed and low power consumption. In some examples, the system 100 can be duty-cycled for further reductions in power consumption. In these examples, the digital portion of the system may operate for a predetermined number of clock cycles, and then may not operate for a second predetermined number of clock cycles, and then may repeat. This is beneficial for battery-powered applications in which preserving sufficient bandwidth and extending battery life are important considerations.

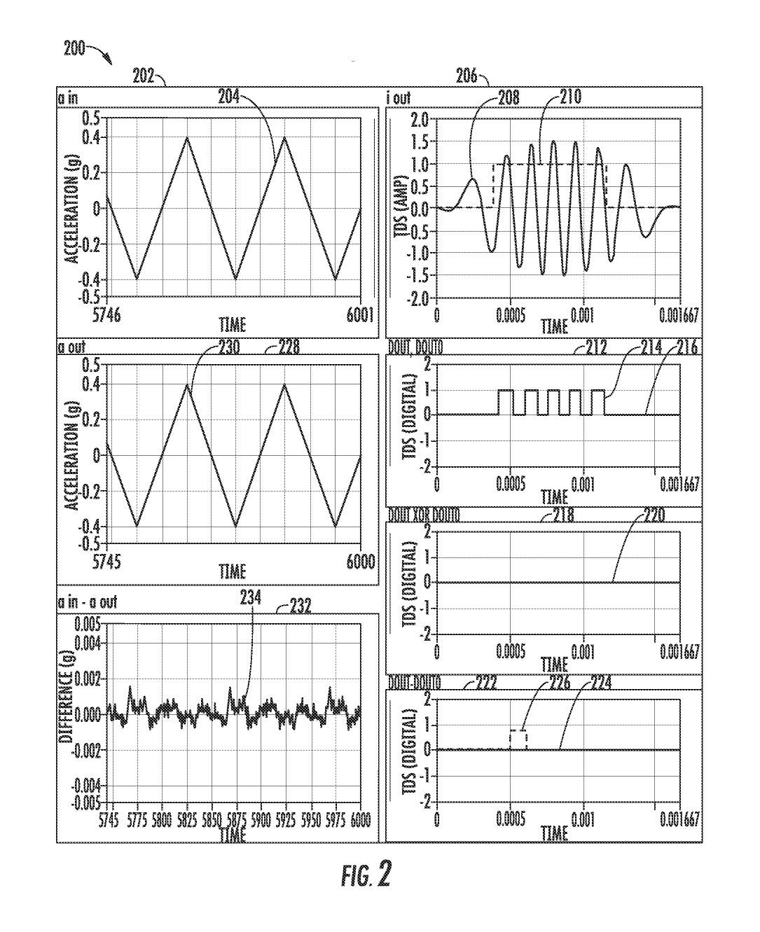

FIG. 2 depicts a graph 200 illustrating various signals of the system 100, focusing on a time interval during which the input inertial parameter 102 is zero. The graph 200 includes an input acceleration sub-graph 202. The input acceleration graph 202 includes an acceleration curve 204 representing the input acceleration as a function of time. In this example, the input inertial parameter 102 is acceleration. The graph 200 also includes an analog signal sub-graph 206. The analog signal sub-graph 206 includes an analog output signal curve 208 and a time mask window curve 210. The analog output signal curve 208 represents the MEMS output signal 106. In the sub-graph 206, the curve 208 represents a current measured by a TIA, but the curve 208 can represent any other analog signal from the MEMS component 104. The time mask curve 210 represents a window over which the window circuit 116 selects the selected portion 118 for output.

The graph 200 includes a digital pulse stream curve 214 and a reference pulse stream 216. The digital pulse stream curve 214 corresponds to the digital pulse stream 109, and the reference pulse stream curve 216 corresponds to the reference pulse stream 144. As depicted in the sub-graph 212, the curves 214 and 216 are identical, indicating that the input inertial parameter 102 has a magnitude of zero.

The graph 200 also includes an XOR output sub-graph 218. The XOR sub-graph 218 depicts a combined pulse stream curve 220. The combined pulse stream 220 represents the combined pulse stream 122. As depicted in FIG. 2, because the input inertial parameter 102 has a magnitude of zero, the combined pulse stream curve 220 is likewise zero at all points in time.

The graph 200 also includes a polarized signal sub-graph 222. The polarized signal sub-graph 222 includes a polarized pulse stream curve 224 and a sign detection window 226. The polarized pulse stream curve 224 corresponds to the polarized pulse stream 148. The sign detection circuit 150 detects the polarity of the first pulse within the sign detection window 226 to determine a value for the polarity signal 152.

The graph 200 includes a measurement sub-graph 228. The measurement sub-graph 228 includes a measured acceleration curve 230. The measured acceleration curve 230 corresponds to the output inertial signal 156 and is the result of the measurement of the system 100. The graph 200 also includes a difference sub-graph 232. The difference sub-graph 232 includes a difference curve 234. The difference curve 234 represents a difference between the input acceleration curve 204 and the measured acceleration curve 230. Thus, the difference curve 234 represents the error in the measurement of the output signal 156.

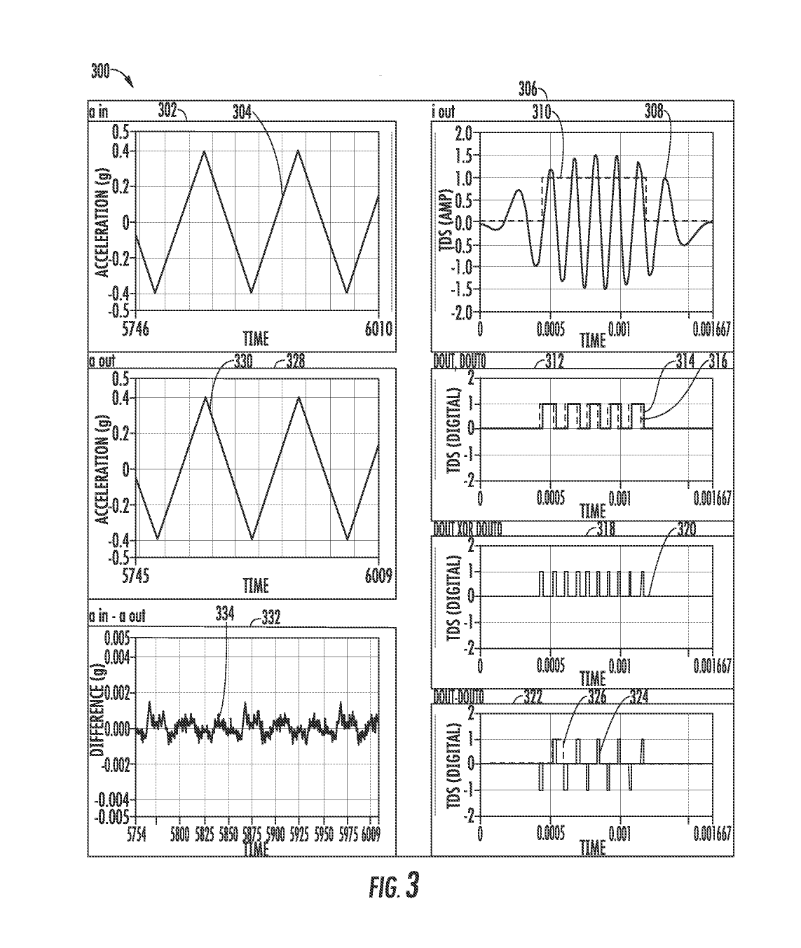

FIG. 3 depicts a graph 300 representing various signals of the system 100, focusing on a time interval during which a small acceleration exists. The graph 300 includes an input acceleration sub-graph 302. The input acceleration graph 302 includes an acceleration curve 304 representing the input acceleration as a function of time. In this example, the input inertial parameter 102 is acceleration. The graph 300 also includes an analog signal sub-graph 306. The analog signal sub-graph 306 includes an analog output signal curve 308 and a time mask window curve 310. The analog output signal curve 308 represents the MEMS output signal 106. In the sub-graph 306, the curve 308 represents a current measured by a TIA, but the curve 308 can represent any other analog signal from the MEMS component 104. The time mask curve 310 represents a window over which the window circuit 116 selects the selected portion 118 for output.

The graph 300 includes a digital pulse stream curve 314 and a reference pulse stream 316. The digital pulse stream curve 314 corresponds to the digital pulse stream 109, and the reference pulse stream curve 316 corresponds to the reference pulse stream 144.

The graph 300 also includes an XOR output sub-graph 318. The XOR sub-graph 318 depicts a combined pulse stream curve 320. The combined pulse stream 320 represents the combined pulse stream 122.

The graph 300 also includes a polarized signal sub-graph 322. The polarized signal sub-graph 322 includes a polarized pulse stream curve 324 and a sign detection window 326. The polarized pulse stream curve 324 corresponds to the polarized pulse stream 148. The sign detection circuit 150 detects the polarity of the first pulse within the sign detection window 326 to determine a value for the polarity signal 152.

The graph 300 includes a measurement sub-graph 328. The measurement sub-graph 328 includes a measured acceleration curve 330. The measured acceleration curve 330 corresponds to the output inertial signal 156 and is the result of the measurement of the system 100. The graph 300 also includes a difference sub-graph 332. The difference sub-graph 332 includes a difference curve 334. The difference curve 334 represents a difference between the input acceleration curve 304 and the measured acceleration curve 330. Thus, the difference curve 334 represents the error in the measurement of the output signal 156.

Because the input inertial parameter 102 is non zero for the time interval depicted in sub-graphs 306, 312, 318, and 322, the pulses of the selected portion pulse stream 314 are offset in time from the reference pulse stream curve 316. This offset results in a series of pulses in the combined pulse stream curve 320 and in the polarized pulse stream curve 324. The integral of the combined pulse stream curve 320 is proportional to the magnitude of the input inertial parameter 102. Because the first pulse contained within the sign detection window 326 is positive, the sign detection circuit 150 outputs a value of +1 as the polarity signal 152.

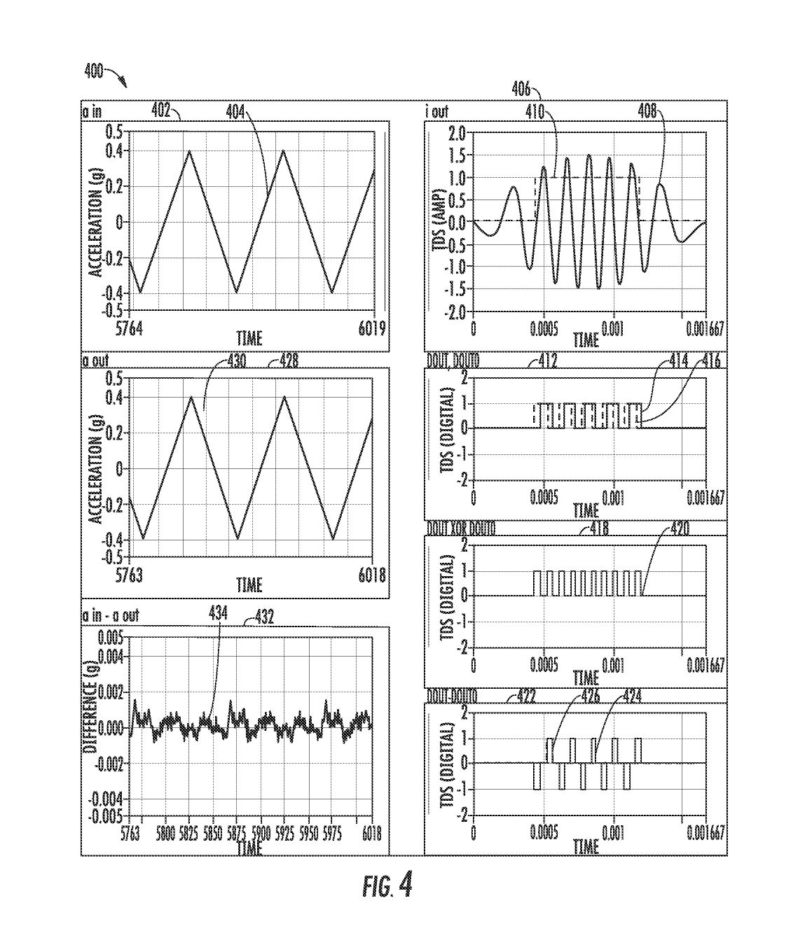

FIG. 4 depicts a graph 400 representing various signals of the system 100, with the right-hand column focusing on a time interval during which the input inertial parameter 102 has a larger magnitude than during the time interval depicted in FIG. 3. The graph 400 includes an input acceleration sub-graph 402. The input acceleration graph 402 includes an acceleration curve 404 representing the input acceleration as a function of time. In this example, the input inertial parameter 102 is acceleration. The graph 400 also includes an analog signal sub-graph 406. The analog signal sub-graph 406 includes an analog output signal curve 408 and a time mask window curve 410. The analog output signal curve 408 represents the MEMS output signal 106. In the sub-graph 406, the curve 408 represents a current measured by a TIA, but the curve 408 can represent any other analog signal from the MEMS component 104. The time mask curve 410 represents a window over which the window circuit 116 selects the selected portion 118 for output.

The graph 400 includes a digital pulse stream curve 414 and a reference pulse stream 416. The digital pulse stream curve 414 corresponds to the digital pulse stream 109, and the reference pulse stream curve 416 corresponds to the reference pulse stream 144.

The graph 400 also includes an XOR output sub-graph 418. The XOR sub-graph 418 depicts a combined pulse stream curve 420. The combined pulse stream 420 represents the combined pulse stream 122.

The graph 400 also includes a polarized signal sub-graph 422. The polarized signal sub-graph 422 includes a polarized pulse stream curve 424 and a sign detection window 426. The polarized pulse stream curve 424 corresponds to the polarized pulse stream 148. The sign detection circuit 150 detects the polarity of the first pulse within the sign detection window 426 to determine a value for the polarity signal 152.

The graph 400 includes a measurement sub-graph 428. The measurement sub-graph 428 includes a measured acceleration curve 430. The measured acceleration curve 430 corresponds to the output inertial signal 156 and is the result of the measurement of the system 100. The graph 400 also includes a difference sub-graph 432. The difference sub-graph 432 includes a difference curve 434. The difference curve 434 represents a difference between the input acceleration curve 404 and the measured acceleration curve 430. Thus, the difference curve 434 represents the error in the measurement of the output signal 156.

As in FIG. 3, the selected portion pulse stream curve 414 is offset in time from the reference pulse stream curve 416. However, because the input inertial parameter 102 has a larger magnitude during the time interval depicted in FIG. 4 than during the time interval depicted in FIG. 3, the offset depicted in FIG. 4 is larger. Thus, the phase shift of the combined pulse stream curve 420 is larger than the phase shift of the combined pulse stream curve 320. Accordingly, the integral of the combined pulse stream curve 420 is larger than the integral of the combined pulse stream curve 320. As in FIG. 3, because the first pulse within the sign detection window 426 is positive, the sign of the inertial parameter 102 is also positive.

FIG. 5 depicts a graph 500 representing various signals of the system 100, with the right-hand column focusing on a time interval during which the input inertial parameter 102 has a non-zero magnitude and a negative polarity. The graph 500 includes an input acceleration sub-graph 502. The input acceleration graph 502 includes an acceleration curve 504 representing the input acceleration as a function of time. In this example, the input inertial parameter 102 is acceleration. The graph 500 also includes an analog signal sub-graph 506. The analog signal sub-graph 506 includes an analog output signal curve 508 and a time mask window curve 510. The analog output signal curve 508 represents the MEMS output signal 106. In the sub-graph 506, the curve 508 represents a current measured by a TIA, but the curve 508 can represent any other analog signal from the MEMS component 104. The time mask curve 510 represents a window over which the window circuit 116 selects the selected portion 118 for output.

The graph 500 includes a digital pulse stream curve 514 and a reference pulse stream 516. The digital pulse stream curve 514 corresponds to the digital pulse stream 109, and the reference pulse stream curve 516 corresponds to the reference pulse stream 144.

The graph 500 also includes an XOR output sub-graph 518. The XOR sub-graph 518 depicts a combined pulse stream curve 520. The combined pulse stream 520 represents the combined pulse stream 122.

The graph 500 also includes a polarized signal sub-graph 522. The polarized signal sub-graph 522 includes a polarized pulse stream curve 524 and a sign detection window 526. The polarized pulse stream curve 524 corresponds to the polarized pulse stream 148. The sign detection circuit 150 detects the polarity of the first pulse within the sign detection window 526 to determine a value for the polarity signal 152.

The graph 500 includes a measurement sub-graph 528. The measurement sub-graph 528 includes a measured acceleration curve 530. The measured acceleration curve 530 corresponds to the output inertial signal 156 and is the result of the measurement of the system 100. The graph 500 also includes a difference sub-graph 532. The difference sub-graph 532 includes a difference curve 534. The difference curve 534 represents a difference between the input acceleration curve 504 and the measured acceleration curve 530. Thus, the difference curve 534 represents the error in the measurement of the output signal 156.

Because the input inertial parameter 102 has a non-zero magnitude, phase of the selected portion pulse stream curve 514 is different from the phase of the reference pulse stream curve 516. The difference in phase produces a series of pulses in the combined pulse stream curve 520 and the polarized pulse stream curve 524. The integral of the combined pulse stream curve 520 is proportional to the magnitude of the input acceleration. Because the first pulse contained within the sign detection window 526 is negative, the polarity of the input inertial parameter 102 is negative.

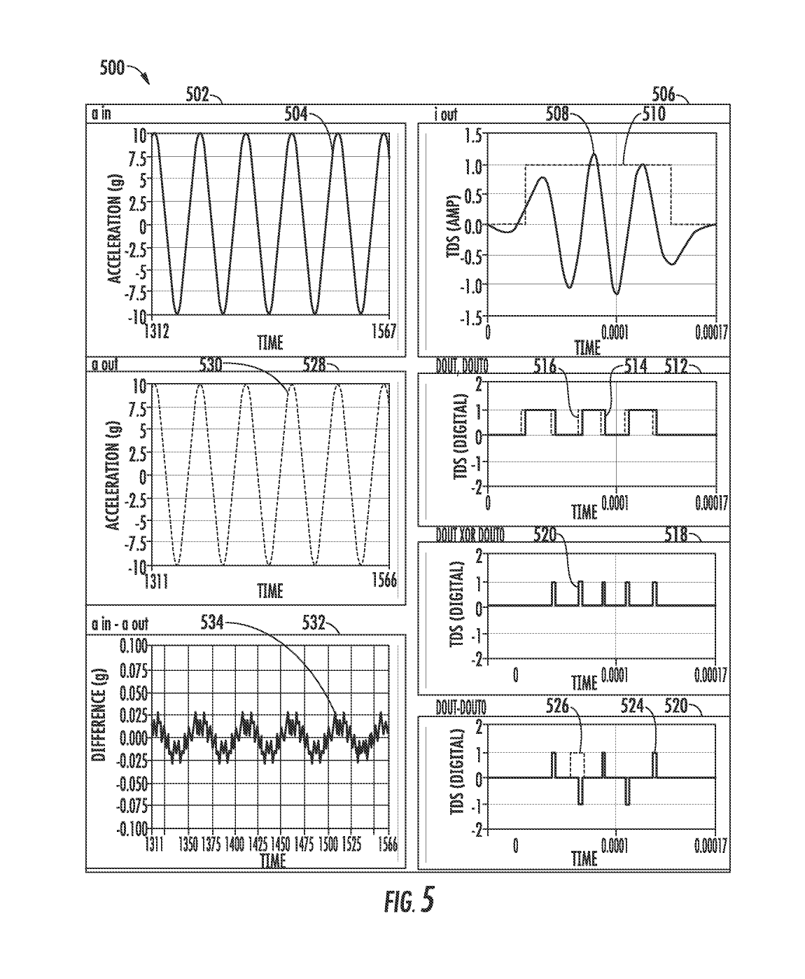

FIG. 6 depicts a graph 600 representing various signals of the system 100, with the right-hand column focusing on a time interval during which the input inertial parameter 102 has a non-zero magnitude and a positive polarity. The graph 600 includes an input acceleration sub-graph 602. The input acceleration graph 602 includes an acceleration curve 604 representing the input acceleration as a function of time. In this example, the input inertial parameter 102 is acceleration. The graph 600 also includes an analog signal sub-graph 606. The analog signal sub-graph 606 includes an analog output signal curve 608 and a time mask window curve 610. The analog output signal curve 608 represents the MEMS output signal 106. In the sub-graph 606, the curve 608 represents a current measured by a TIA, but the curve 608 can represent any other analog signal from the MEMS component 104. The time mask curve 610 represents a window over which the window circuit 116 selects the selected portion 118 for output.

The graph 600 includes a digital pulse stream curve 614 and a reference pulse stream 616. The digital pulse stream curve 614 corresponds to the digital pulse stream 109, and the reference pulse stream curve 616 corresponds to the reference pulse stream 144.

The graph 600 also includes an XOR output sub-graph 618. The XOR sub-graph 618 depicts a combined pulse stream curve 620. The combined pulse stream 620 represents the combined pulse stream 122.

The graph 600 also includes a polarized signal sub-graph 622. The polarized signal sub-graph 622 includes a polarized pulse stream curve 624 and a sign detection window 626. The polarized pulse stream curve 624 corresponds to the polarized pulse stream 148. The sign detection circuit 150 detects the polarity of the first pulse within the sign detection window 626 to determine a value for the polarity signal 152.

The graph 600 includes a measurement sub-graph 628. The measurement sub-graph 628 includes a measured acceleration curve 630. The measured acceleration curve 630 corresponds to the output inertial signal 156 and is the result of a measurement of the system 100. The graph 600 also includes a difference sub-graph 632. The difference sub-graph 632 includes a difference curve 634. The difference curve 634 represents a difference between the input acceleration curve 604 and the measured acceleration curve 630. Thus, the difference curve 634 represents the error in the measurement of the output signal 156.

Because the polarity of the input inertial parameter 102 during the time interval depicted in sub-graphs 606, 612, 618, and 622 is positive, the sign detection window 626 contains a positive pulse and the phase of the selected portion pulse stream curve 614 leads the phase of the reference pulse stream curve 616. Accordingly, during the time interval depicted in sub-graphs 606, 612, 618, and 622, the sign detection circuit 150 outputs a value of +1 as the polarity signal 152. By comparing the selected portion pulse stream 118 with the reference pulse stream 144, the system 100 measures the magnitude and polarity of the input inertial parameter 102. The system 100 produces the output inertial signal 156 as this measurement.

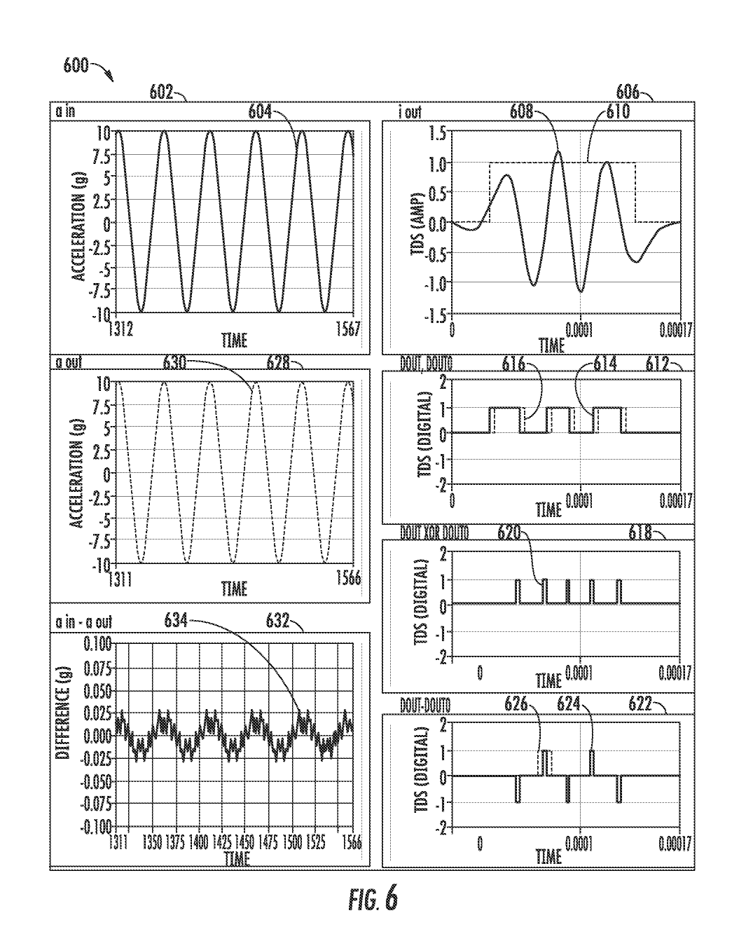

FIG. 7 depicts a graph 700 showing acceleration signals and a graph 750 showing a frequency spectrum. The graph 700 includes a sub-graph 702 depicting an input acceleration curve 704. The acceleration curve 704 corresponds to the input inertial parameter 102. The graph 700 also includes a measured acceleration sub-graph 728. The measured acceleration sub-graph 728 depicts a measured acceleration curve 730, which represents an acceleration measured by the system 100. The measured acceleration curve 730 can correspond to the output inertial signal 156. The graph 700 also includes a difference sub-graph 732. The difference sub-graph 732 depicts a difference curve 734, representing the difference between the input acceleration curve 704 and the measured acceleration curve 730. The frequency spectrum graph 750 depicts a spectrum curve 752, representing the frequency components of the measured acceleration curve 730. The spectrum curve 752 depicts a significant low frequency component at the frequency of the input acceleration with less significant high-frequency components.

FIG. 7 also includes a bandwidth table 770. The bandwidth table 770 illustrates the relationship between the number of oscillation cycles (of the oscillating mass of the MEMS component 102) over which the counter circuit 124 integrates and the bandwidth and resolution of the system 100. In the example depicted in the table 770, integrating over one oscillation cycle results in a bandwidth of 1400 Hz and a resolution of 0.001 g. However, integrating over 10 oscillation cycles lowers the bandwidth to 140 Hz but improves the resolution to 0.0001 g. The table 770 is merely illustrative, and other relationships can exist, and other numbers of integration cycles can be used.

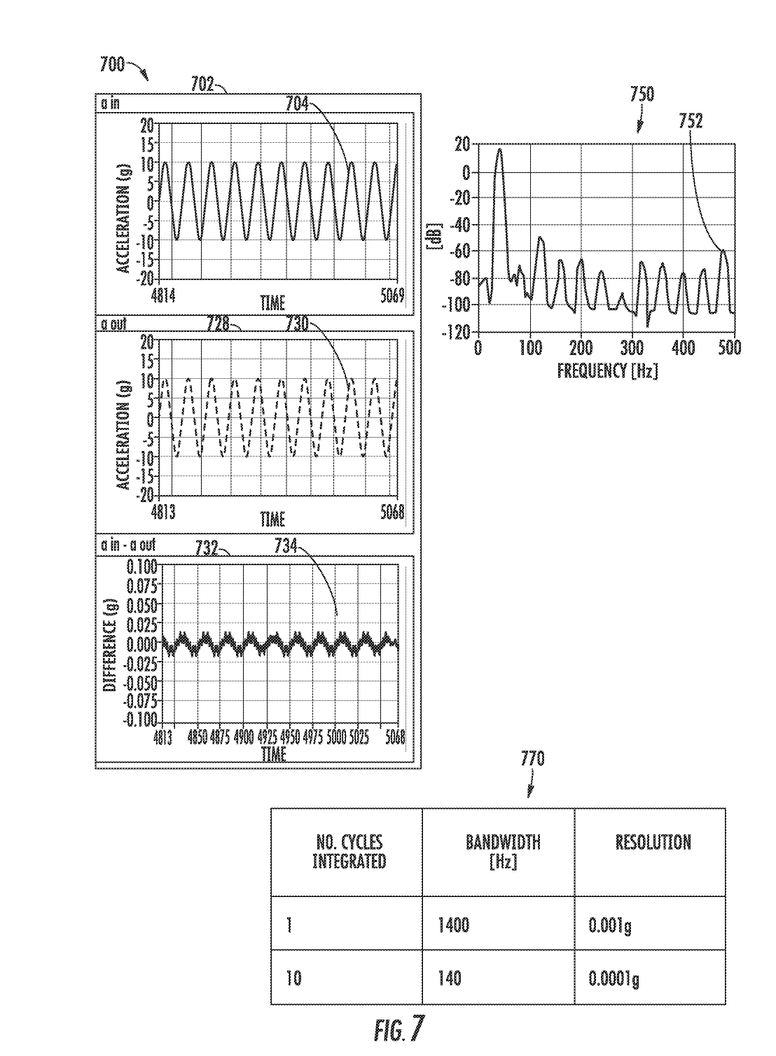

FIG. 8 depicts three views 800, 830, and 860, each showing a schematic representation of parts of a moveable element 802 and a fixed element 804. The MEMS component 102 can include the moveable element 802 and the fixed element 804. The oscillating mass of the MEMS component 102 can include the moveable element 802. The movable element 802 and the fixed element 804 depicted in FIG. 8 each include a plurality of structures, or beams. In particular, the fixed element 804 includes beams 806a, 806b, and 806c (collectively, beams 806). The moveable element 802 depicted in FIG. 8 includes beams 808a and 808b (collectively, beams 808). The moveable element 802 is separated from the fixed element 804 by a distance W0 832. The distance W0 832 can change as the moveable element 802 oscillates with respect to the fixed element 804. The distance W0 832 affects parasitic capacitance between the movable element 802 and the fixed element 804. The distance W0 832 is selected to minimize parasitic capacitance when the movable element 802 is in the rest position, while maintaining manufacturability of the sensor. The view 860 depicts an area of interest noted by the rectangle 840 of view 830.

Each of the beams 806 and 808 includes multiple sub-structures, or teeth, protruding perpendicularly to the long axis of the beams. The beam 806b includes teeth 810a, 810b, and 810c (collectively, teeth 810). The beam 808b includes teeth 812a, 812b and 812c (collectively, teeth 812). Adjacent teeth on a beam are equally spaced according to a pitch 862. Each of the teeth 810 and 812 has a width defined by the line width 866 and a depth defined by a corrugation depth 868. Opposing teeth are separated by a tooth gap 864. As the moveable beam 808b oscillates along the moving axis 801 with respect to the fixed beam 806b, the tooth gap 864 remains unchanged. In some examples, manufacturing imperfections cause the tooth spacing to deviate from the pitch 862. However, provided that the deviation is negligible compared to the pitch 862, the deviation does not significantly impact operation of the sensor and can be neglected for the purposes of this disclosure.

A capacitance exists between the fixed beam 806b and the moveable beam 808b. As the moveable beam 808b oscillates along the moving axis 801 with respect to the fixed beam 806b, the capacitance changes. The capacitance increases as opposing teeth of the teeth 810 and 812 align with each other and decreases as opposing teeth become less aligned with each other. At the position depicted in the view 860, the capacitance is at a maximum and the teeth 810 are in an aligned position with respect to the teeth 812. As the moveable beam moves monotonically along the moving axis 801, the capacitance changes non-monotonically, since a maximum in capacitance occurs as the teeth are in an aligned position.

The capacitance can be degenerate, meaning that the same value of capacitance can occur at different displacements of the moveable beam 808b. When the moveable beam 808b has moved from its rest position by a distance equal to the pitch 862, the capacitance is the same as when the moveable beam 808b is in the rest position.

FIG. 9 depicts a planform view schematic of a gyroscope 900. The gyroscope 900 includes a right-hand coordinate system 948 with x, y, and z, axes. The view 900 depicts a left drive frame 920a and a right drive frame 920b (collectively, drive frames 920) springedly coupled by a spring element 966. The drive frames 920 are oscillated synchronously and in opposite directions along the x axis by driving structures (not shown). The gyroscope 900 can represent the MEMS subsystem 102.

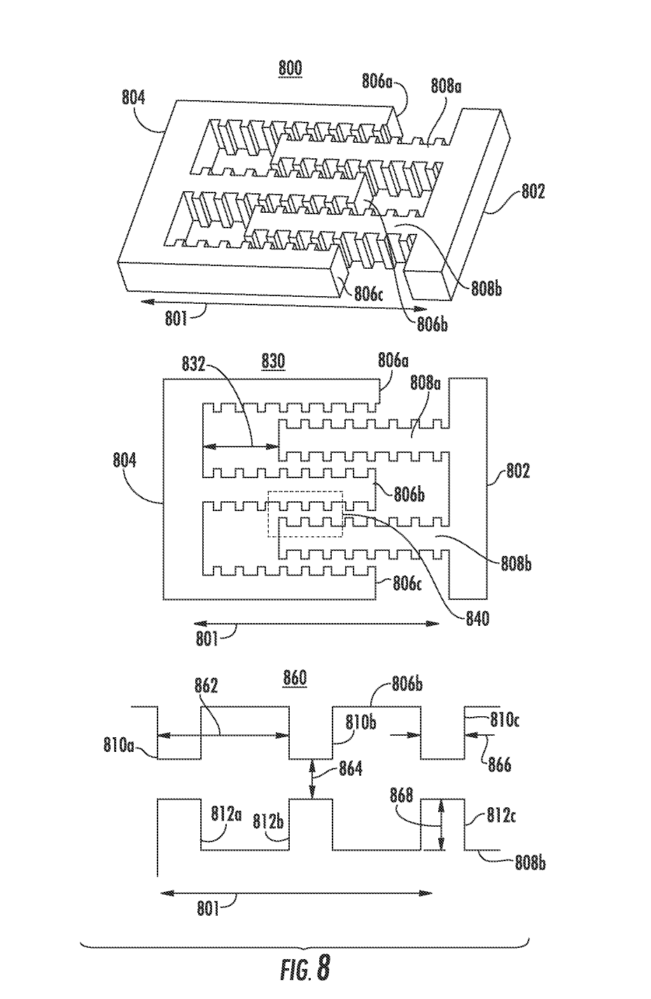

FIG. 10 depicts a perspective view of the gyroscope 900 undergoing both oscillation and rotation. The gyroscope 900 includes sense masses 1022a and 1022b (collectively, sense masses 1022). The sense masses 1022a and 1022b are springedly coupled to drive frames 920a and 920b, respectively. As the drive frames 920 oscillate with equal and opposite velocity along the x axis, the sense masses 1022 also oscillate along the x axis. As the gyroscope 900 experiences an external rotation about y axis, the sense masses 1022 are deflected along the z axis with equal and opposite displacements. This displacement along the z axis due to rotation about they axis is due to the Coriolis effect and is proportional to the cross product of the velocity of the sense mass along the x axis and the rotation rate about they axis. In some examples, the sense masses 1022 may also experience displacement in the z axis due to quadrature and/or acceleration. By detecting displacements of the sense masses along the z axis, rotation of the gyroscope 900 about they axis can be detected and quantified. The drive frames 920 can include moveable beams 808, and an overall frame can include fixed beams 806. Together, these can be used to measure velocity of the drive frames 920.

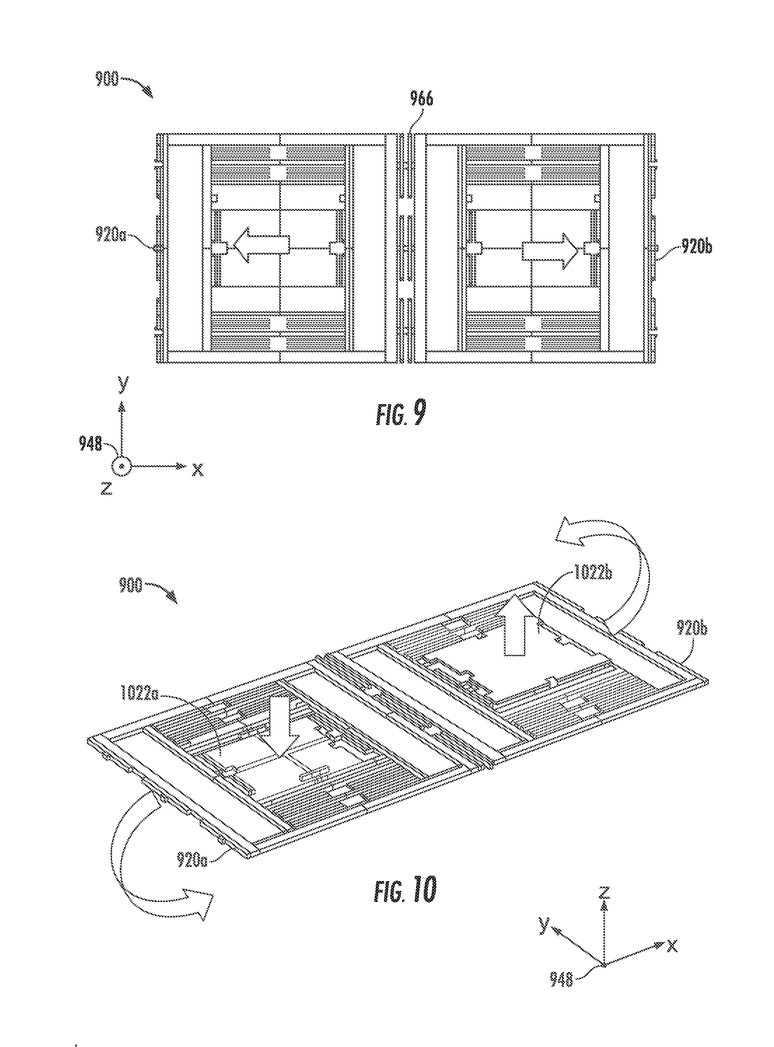

FIG. 11 schematically depicts an exemplary process used to extract inertial information from an inertial sensor with periodic geometry. FIG. 11 includes an inertial sensor 1100 which experiences an external perturbation 1101. The inertial sensor 1100 can include the system 100, and the external perturbation 1101 can include the input inertial parameter 102. A drive signal 1110 causes a movable portion of the sensor 1100 to oscillate. The moveable portion can be the moveable element 802. An AFE electrically connected to the moveable element 802 and to the fixed element 804 measures the capacitance between them and outputs a signal based on the capacitance. The AFE can do this by measuring a capacitive current or a charge. Zero-crossings of the AFE output signal occur when the AFE output signal momentarily has a magnitude of zero. Zero-crossings of an output signal from the inertial sensor 1100 are generated at 1102 and 1104 and combined at 1106 into a combined signal. A signal processing module 1108 processes the combined analog signal to determine inertial information. One or more processes can convert the combined analog signal into a rectangular waveform 1112. This can be accomplished using a comparator, by amplifying the analog signal to the rails, or by other methods.

The rectangular waveform 1112 comprises a rectangular pulse stream having high and low values, with no substantial time spent transitioning between high and low values. Transitions between high and low values correspond to zero-crossings of the combined analog signal. The transitions between high and low values and zero-crossings occur when a displacement 1118 of the movable element 802 crosses reference levels 1114 and 1116. The reference levels 1114 and 1116 correspond to physical locations of movable portions of the sensor 1100. Because the zero-crossings are associated with specific physical locations, displacement information can be reliably determined independent of drift, creep and other factors which tend to degrade performance of inertial sensors.

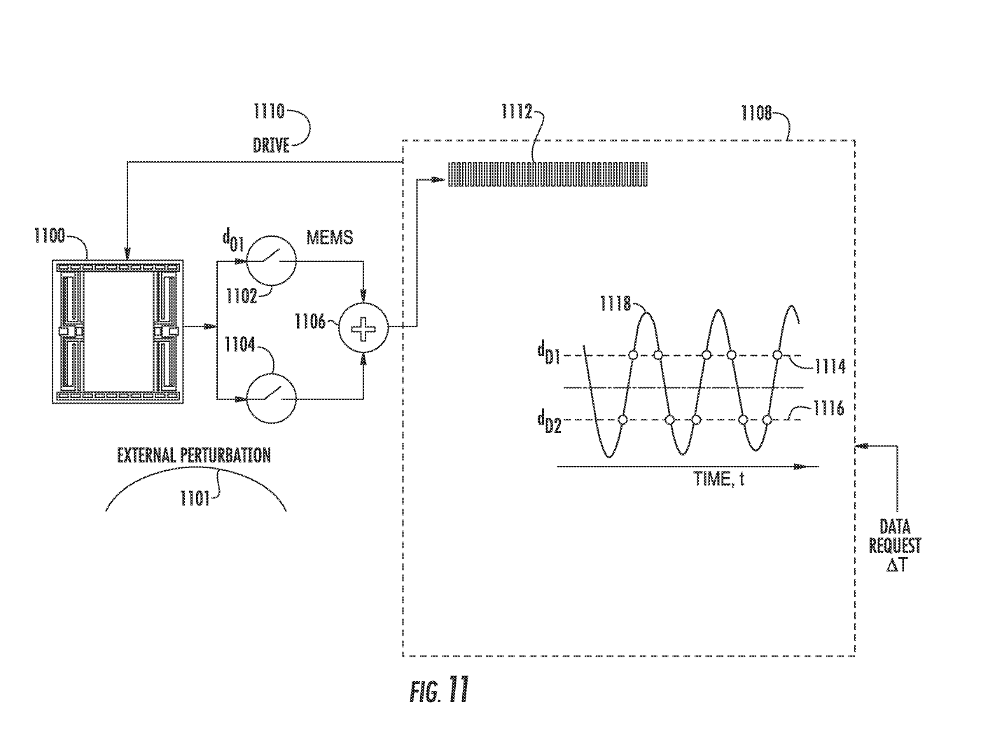

FIG. 12 depicts a graph 1200 which represents the association of analog signals derived from the inertial sensor 1100 with zero-crossing times and displacements of the inertial sensor. The graph 1200 represents signals derived from an oscillator in which opposing teeth are aligned at the rest position. The graph 1200 includes curves 1202, 1204 and 1206. The curve 1202 represents an output of an analog front end such as a TIA. Since a TIA outputs a signal proportional to its input current, the curve 1202 represents a capacitive current measured between movable and fixed elements of an inertial device such as the inertial device 1100. The curve 1206 represents an input acceleration that is applied to the inertial device 1100. The input acceleration represented by the curve 1206 is a 15 g acceleration at 20 Hz. The curve 1204 represents displacement of the movable element of the inertial device 1100 as it oscillates.

FIG. 12 includes square symbols indicating points on the curve 1202 at which the curve 1202 crosses the zero level. These zero-crossings in the current represent local maxima or minima (extrema) of capacitance between the movable element and the fixed element of the inertial device, because capacitive current is proportional to the first derivative of capacitance. FIG. 12 includes circular symbols indicating points on the curve 1204 corresponding to times at which the curve 1202 crosses zero. The circular symbols indicate the correlation between physical position of a movable element of the oscillator and zero-crossing times of the outputs of signal 1202.

At the time 1218, the curve 1202 crosses zero because the displacement of the movable element of the oscillator is at a maximum and the oscillator is at rest, as indicated by the displacement curve 1204. Here, capacitance reaches a local extremum because the movable element has a velocity of zero, not necessarily because teeth or beams of the oscillator are aligned with opposing teeth or beams. At time 1220, the TIA output curve 1202 crosses zero because the oscillator displacement reaches the +d₀ location 1208. The +d₀ location 1208 corresponds to a displacement in a position direction equal to the pitch distance and is a point at which opposing teeth or beams are aligned to produce maximum capacitance. At time 1222, the TIA output curve 1202 crosses zero because the movable element of the oscillator is at a position at which the teeth are anti-aligned. This occurs when the teeth of the movable element 802 are in an aligned position with the centers of gaps between teeth of the fixed element 804, resulting in a minimum in capacitance. This minimum in capacitance occurs at a location of +d₀/2 1210, corresponding to a displacement to one-half the pitch distance in the positive direction.

At time 1224, the TIA output curve 1202 crosses zero because teeth of the movable element 802 are aligned with teeth of the fixed element 804, producing a maximum in capacitance. The time 1224 corresponds to a time at which the movable element is at the rest position, indicated by the zero displacement 1212 on the curve 1204. At time 1226, the TIA output 2202 crosses zero because teeth of the movable element 802 are anti-aligned with teeth of the fixed element 804, producing a local minimum in capacitance. This anti-alignment occurs at a displacement of −d₀/2 1214, corresponding to a displacement of one-half the pitch distance in the negative direction.

At time 1228, the TIA output 1202 crosses zero because the teeth of the movable element 802 are in an aligned position with respect to the teeth of the fixed element 804, creating a local maximum in capacitance. This local maximum in capacitance occurs at a displacement of −d₀ 1216, corresponding to a displacement equal to such distance in the negative direction. At time 1230, the TIA output curve 1202 crosses zero because the movable element 802 has a velocity of zero as it reverses direction. This reversal of direction is illustrated by the displacement curve 1204. As at time 1218, when the movable element has a velocity of zero, capacitance is not changing with time and thus the current and TIA output (which are proportional to the first derivative of capacitance) are zero.

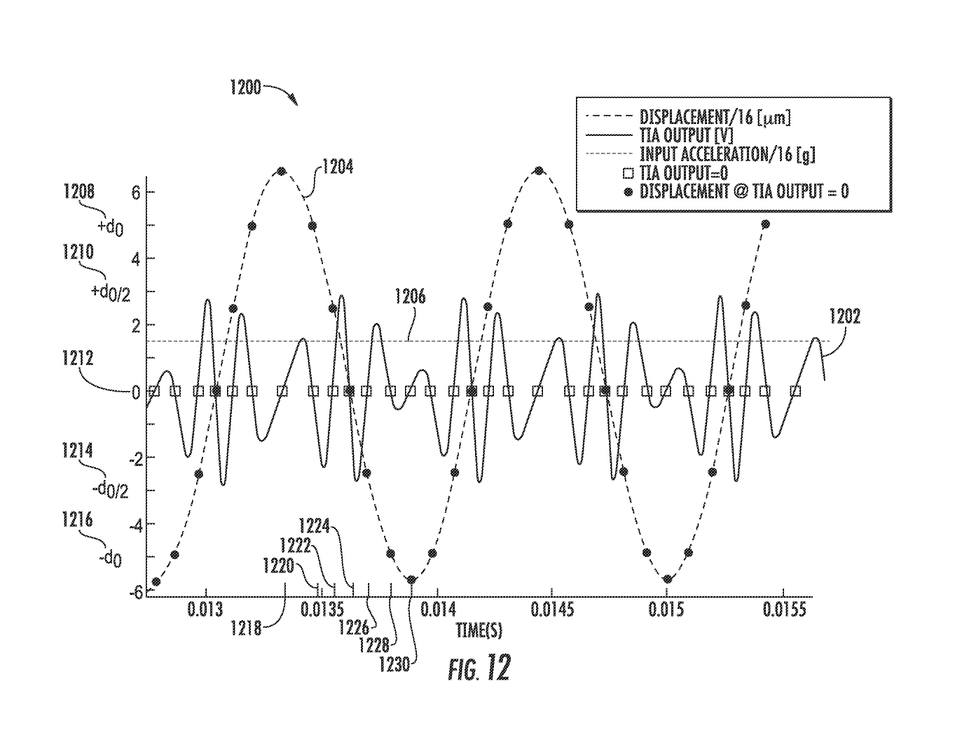

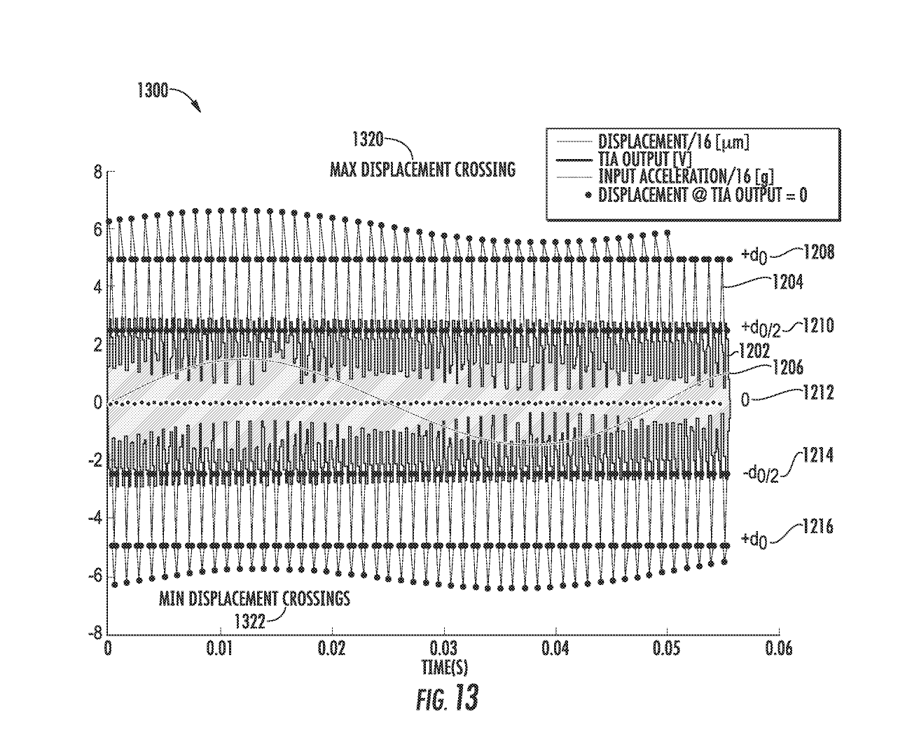

FIG. 13 depicts a graph 1300 showing the effect of an external perturbation on input and output signals of the inertial sensors described herein. The graph 1300 includes the TIA output curve 1202, the displacement curve 1204, and the input acceleration curve 1206. The graph 1300 depicts the same signals depicted in the graph 1200, and the only difference is that the graph 1300 represents a longer duration of time then the graph 1200. With a longer duration of time displayed in the graph 1300, the periodicity of the input acceleration curve 1206 is more easily discerned. In addition, maximum displacement crossings 1320 and minimum displacement crossings 1322 can be discerned in the graph 1300 to experience a similar periodicity. In contrast to the maximum displacement crossings 1320 and the minimum displacement crossings 1322, the amplitude of which varies with time, zero-crossings of the TIA output signal 1202 triggered by alignment or anti-alignment of teeth of the fixed and movable elements 804 and 802 at the locations +d₀/2 1208, 0 1212, −d₀/2 1214, and −d₀ 1216 are stable with time. These reference crossings, the amplitude of which are stable with time, provide stable, drift-independent indications of oscillator displacement and can be used to extract inertial parameters.

FIG. 14 depicts a graph 1400 that illustrates the response of a current to an oscillator displacement. The graph 1400 includes a current curve 1402 and a displacement curve 1404. The current curve 1402 represents an input signal for a TIA. The TIA may produce an output signal such as the TIA output curve 1202 in response. The current curve 1402 is a capacitive current between the fixed beam 804 and the movable beam 802 in response to displacement of the movable beam 802 according to the displacement curve 1404. The current curve 1402 crosses zero at numerous times, including times 1424, 1426, 1428, and 1430. At the times 1424 and 1430, the movable element 802 has a displacement of −d₀, as shown in the graph 1400. At the times 1426 and 1428, the movable element 802 has a displacement of +d₀, shown on the graph 1400.

The graph 1400 includes two time intervals T₄₃ 1432 and T₆₁ 1434. The time interval T₄₃ 1432 corresponds to the difference in time between time 1426 and time 1428. The time interval T₆₁ 1434 corresponds to the time difference between times 1424 and 1430. Thus, time interval T₆₁ 1434 corresponds to the time between subsequent crossings of the −d₀ 1416 level, and the time interval T₄₃ 1432 corresponds to the time interval between subsequent crossings of the +d₀ 1408 level. The methods used to determine the time intervals T₄₃ 1432 and T₆₁ 1434 can be used to determine other time intervals, such as between a crossings of the +d₀ 1408 and the next subsequent crossing of the −d₀ 1416, between a time interval between a crossing of the −d₀ 1416 and the next crossing of the +d₀ 1408, between the time 1430 and the next crossing of the +d₀ 1408, between crossings of the zero 1412, between zero-crossings due to a maximum or minimum of displacement, or between any other combination of zero-crossings of the current curve 2002 or a TIA output signal corresponding to the current curve 1402.

FIG. 15 depicts a graph 1500 showing a rectangular waveform signal representing zero-crossing times of the current signal 1402. The graph 1500 includes a rectangular waveform curve 1536. The rectangular waveform curve 1536 has substantially two values: a high value and a low value. While the rectangular waveform curve 1536 may have intermediate values as it transitions between the high and low values, the time spent at intermediate values is far less than the combined time spent at the high and low of the values.

The rectangular waveform curve 1536 can be produced by a variety of methods, including using a comparator to detect changes in an input signal, by amplifying an input signal to the limits of an amplifier so as to saturate the amplifier (amplifying to the rails), by using an analog-to-digital converter, and the like. One way to produce this rectangular waveform curve 1536 from the current curve 1402 is to use a comparator to detect zero-crossings of the current curve 1402. When the current curve 1402 has a value greater than a reference level (such as zero), the comparator outputs a high value, and when the current curve 1402 has a value less than the reference level (such as zero), the comparator has a low value. The comparator's output transitions from low to high when the current curve 1402 transitions from a negative value to a positive value, and the comparator's output transitions from high to low when the current curve 1402 transitions from a positive value to a negative value. Thus, times of rising edges of the rectangular waveform curve 1536 correspond to times of negative-to-positive zero-crossings of the current curve 1404, and falling edges of the rectangular waveform curve 1536 correspond to positive-to-negative zero-crossings of the current curve 1402.

The rectangular waveform curve 1536 includes the same time intervals 1432 and 1434 as the current curve 1402. One benefit of converting the current curve 1402 to a rectangular waveform signal such as the rectangular waveform curve 1536 is that in a rectangular waveform signal, rising and falling edges are steeper. Steep rising and falling edges provide more accurate resolution of the timing of the edges and lower timing uncertainty. Another benefit is that rectangular waveform signals are amenable to digital processing.

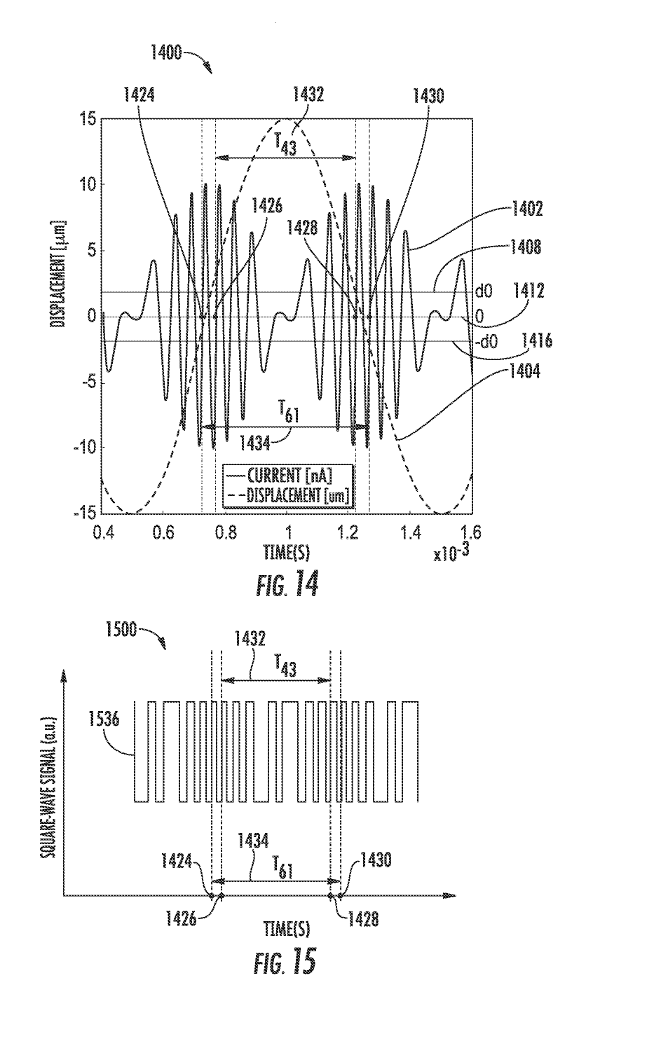

FIG. 16 depicts a graph 1600 which illustrates additional time intervals of displacement curve 1404. In addition to the times depicted in the graph 1400, the graph 1600 includes times 1636 and 1638. In addition to the time intervals depicted in the graph 1400, the graph 1600 includes the time interval T₉₄ 1640 and the time interval T₇₆ 1642. The time interval T₉₄ 1640 corresponds to the time interval between times 1438 and 1638, both crossings of the d₀ 1408 level. The time interval T₇₆ 1642 corresponds to the time interval between times 1430 and 1636, both crossings of the −d₀ 1416 level.

As can be seen in FIG. 12, the oscillator displacement as shown by the displacement curve 1204 experiences an offset that is correlated with input acceleration as indicated by the acceleration curve 1206. Thus, one way to detect shifts of the displacement curve 1404 and thus input acceleration is to compare relative positions of zero-crossing times. For example, a sum of the time intervals T₄₃ 1432 and T₉₄ 1640 represents a period of oscillation as does a sum of the periods T₆₁ 1434 and T₃₆ 1642. In comparing a subset of the period, such as comparing the time interval T₄₃ 1432 with the sum of T₄₃ 1432 and T₉₄ 1640 represents the proportion of time that the oscillator spends at a displacement greater than +d₀ 1408. An increase in this proportion from a reference proportion indicates a greater acceleration in a positive direction than the reference. Likewise, a decrease in this proportion from the reference indicates a greater acceleration in the negative direction. Integrating portions of the rectangular waveform using the systems and methods described herein can be performed to determine relative positions of zero-crossing times and thus acceleration, rotation and/or velocity.

FIG. 17 depicts the relationship between capacitance of the inertial sensor 1100 and displacement of the moving element 802. FIG. 17 includes a capacitance curve 1702 that is periodic and substantially sinusoidal. Thus, monotonic motion of the movable element 102 produces a capacitance that changes non-monotonically with displacement. This non-monotonically is a function of the geometric structure of the sensor 100 and the manner in which the sensor 100 is excited.

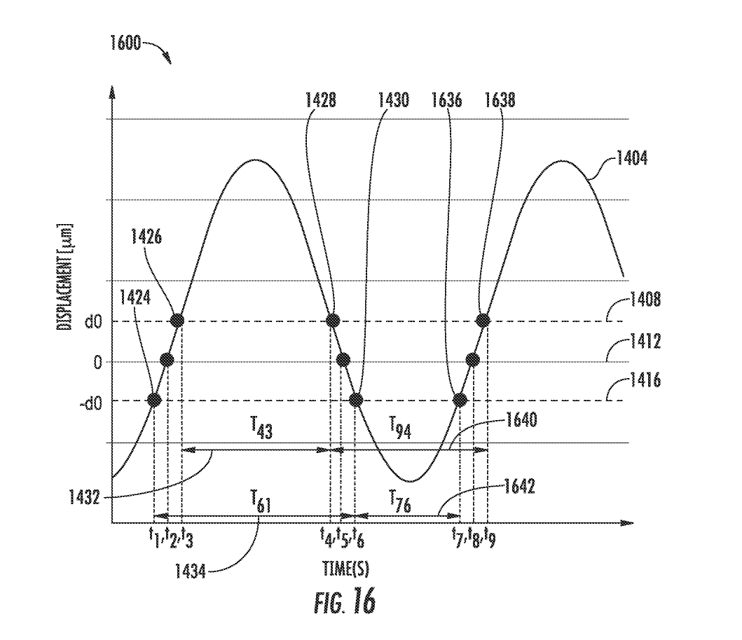

FIG. 18 depicts the relationship between displacement and the first derivative of capacitance with respect to displacement. FIG. 18 includes a dC/dx curve 1802 which is periodic and substantially sinusoidal. The dC/dx curve 1802 is the first derivative of the capacitance curve of 1702. As such, the dC/dx curve 1802 crosses zero when the capacitance curve 1702 experiences a local extremum. Capacitive current is proportional to the first derivative of capacitance and thus proportional to, and shares zero-crossings with, the dC/dx curve 1802.

FIG. 19 depicts the relationship between displacement and the second derivative of capacitance with respect to displacement. FIG. 19 includes a d²C/dx² curve 1902. The dC/dx² curve 1902 is the first derivative of the dC/dx curve 1802 and as such has a value of zero at local extrema of the dC/dx curve 1802. The d²C/dx² curve 1902 indicates the slope of the dC/dx curve 1802 and thus indicates locations at which the current is most rapidly changing. In some implementations, it is desirable to maximize the amplitude of the d²C/dx curve 1902 to maximize the steepness of the current curve. This reduces uncertainty in resolving timing of zero-crossings of the current. Reducing uncertainty of the zero-crossing times results in decreased system noise and decreased jitter, as well as, lower gain required of the system. Decreased jitter results in improved resolution of external perturbations. In some implementations, it is desirable to minimize the impact of variable parasitic capacitance, which is parasitic capacitance that varies with oscillator motion.

FIG. 20 depicts the relationship between time, the rate of change of capacitive current, and displacement. FIG. 20 includes a dI/dt curve 2002. The capacitive current used to determine the dI/dt curve 2002 is obtained by applying a fixed voltage across the capacitor used to produce the capacitive curve 1702. The dI/dt curve 2002 represents the rate at which the capacitive current is changing with time and thus provides an indicator of the steepness of the current slope. High magnitudes of the dI/dt signal indicate rapidly changing current and high current slopes. Since the oscillator used to generate the curves shown in FIGS. 17-20 oscillates about zero displacement and reverses direction at displacements of +15 [symbol] m and −15 [symbol] m, the velocity of the oscillator is lowest at its extrema of displacement. At these displacement extrema, the current is also changing less rapidly and thus the dI/dt curve 2002 has a lower magnitude. Using zero-crossings at which the dI/dt curve 2002 has large values results in improved timing resolution and decreased jitter. These zero-crossings occur near the center of the oscillator's range.

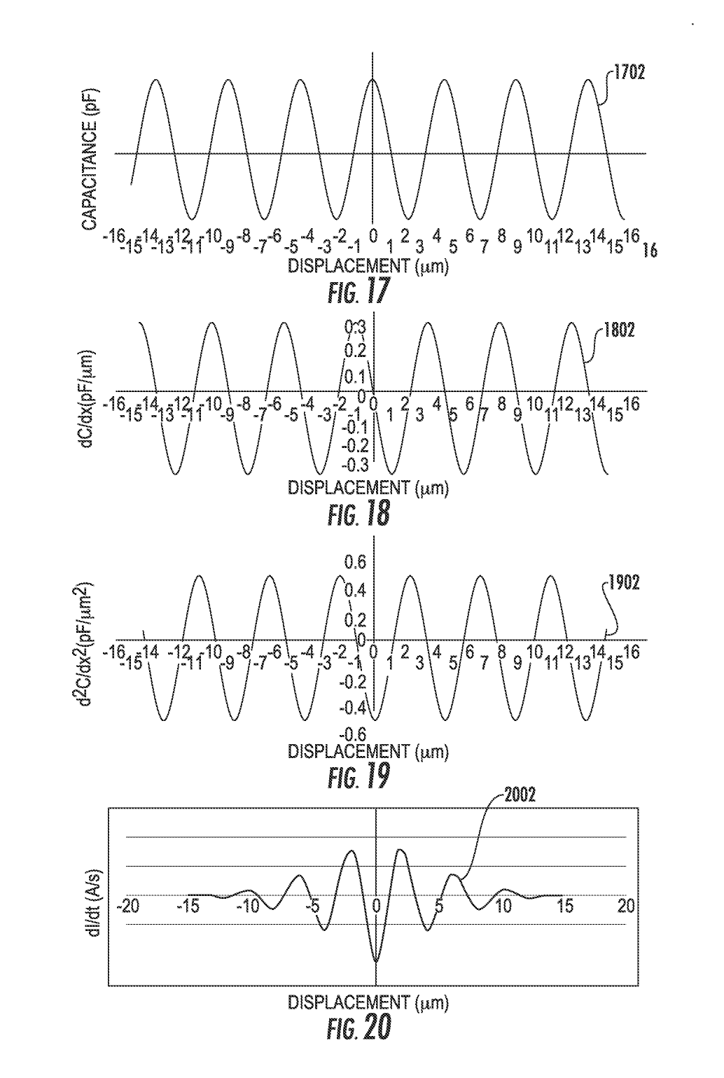

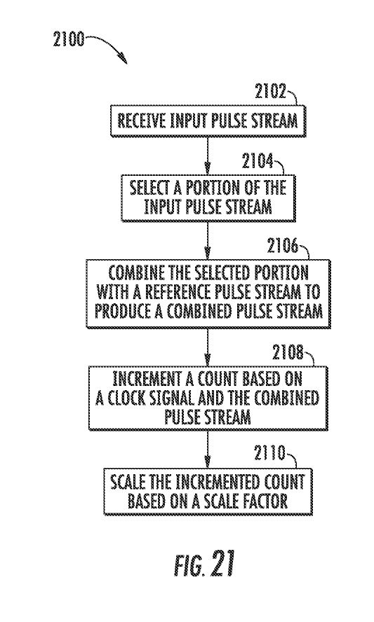

FIG. 21 depicts a flow chart of a method 2100 for integrating to determine inertial parameters. The method 2100 can be implemented by the system 100. At 2102, an input pulse stream is received. The input pulse stream can be the digital pulse stream 109.

At 2104, a portion of the input pulse stream is selected. The portion that is selected can be the selected portion 118. The window circuit 116 can implement the steps 2102 and 2104.

At 2106, the selected portion is combined with a reference pulse stream to produce a combined pulse stream. The combined pulse stream can be the combined pulse stream 122. The XOR circuit 120 can implement the step 2106.

At 2108, a count is implemented based on a clock signal and the combined pulse stream. The incremented count can be the incremented count 126, and the clock signal can be the clock signal 132. The counter circuit 124 can implement the step 2108.

At 2110, the incremented count is scaled based on a scale factor. The scaling circuit 154 can implement the step 2110. The scale factor can comprise one or more predetermined constants or a polynomial. In some examples, at 2110, the scaling circuit 154 also multiplies by the polarity signal 152. By performing in the method 2100, the system 100 produces an output inertial parameter based on an input pulse stream.

In some examples, the system 100 is included in a single mixed-signal application-specific integrated circuit (ASIC) located on a single substrate. In other examples, the system 100 is distributed between multiple integrated circuits. For example, the analog components (the MEMS component 104, the AFE circuit 108, the drive sense AFE 110, and the drive adjustment loop circuit 112) may be included in one or more analog circuits, and the remainder of the system 100 can be included in one or more digital circuits. The multiple integrated circuits can all be located on a single substrate. In some examples, the multiple integrated circuits can be distributed across multiple substrates that are electrically connected. In some examples, some or all of the system 100 is implemented using one or more digital processors.

The systems described herein can be fabricated using MEMS and microelectronics fabrication processes such as lithography, deposition, and etching. The features of the MEMS structure are patterned with lithography and selected portions are removed through etching. Such etching can include deep reactive ion etching (DRIE) and wet etching. In some examples, one or more intermediate metal, semiconducting, and/or insulating layers are deposited. The base wafer can be a doped semiconductor such as silicon. In some examples, ion implantation can be used to increase doping levels in regions defined by lithography. The oscillating mass can be defined in a substrate silicon wafer, which is then bonded to top and bottom cap wafers, also made of silicon. Encasing the oscillating mass in this manner allows the volume surrounding the mass to be evacuated. In some examples, a getter material such as titanium is deposited within the evacuated volume to maintain a low pressure throughout the lifetime of the device. This low pressure enhances the quality factor of the resonator. From the MEMS structure, conducting traces are deposited using metal deposition techniques such as sputtering or physical vapor deposition (PVD). These conducting traces electrically connect active areas of the MEMS structure to the microelectronic circuits depicted in FIG. 1. Similar conducting traces can be used to electrically connect the microelectronic circuits depicted in FIG. 1 to each other. The fabricated MEMS and microelectronic structures can be packaged using semiconductor packaging techniques including wire bonding and flip-chip packaging.

As used herein, the term “memory” includes any type of integrated circuit or other storage device adapted for storing digital data including, without limitation, ROM, PROM, EEPROM, DRAM, SDRAM, DDR/2 SDRAM, EDO/FPMS, RLDRAM, SRAM, flash memory (e.g., AND/NOR, NAND), memrister memory, and PSRAM.

As used herein, the term “processor” is meant generally to include all types of digital processing devices including, without limitation, digital signal processors (DSPs), reduced instruction set computers (RISC), general-purpose (CISC) processors, microprocessors, gate arrays (e.g., FPGAs), PLDs, reconfigurable compute fabrics (RCFs), array processors, secure microprocessors, and application-specific integrated circuits ASICs. Such digital processors may be contained on a single unitary integrated circuit die, or distributed across multiple components.

From the above description of the system it is manifest that various techniques may be used for implementing the concepts of the system without departing from its scope. For example, in some examples, any of the circuits described herein may be implemented as a printed circuit with no moving parts. Further, various features of the system may be implemented as software routines or instructions to be executed on a processing device (e.g. a general purpose processor, an ASIC, field programmable gate array (FPGA), etc.) The described embodiments are to be considered in all respects as illustrative and not restrictive. It should also be understood that the system is not limited to the particular examples described herein, but can be implemented in other examples without departing from the scope of the claims.

Similarly, while operations are depicted in the drawings in a particular order, this should not be understood as requiring that such operations be performed in the particular order shown or in sequential order, or that all illustrated operations be performed, to achieve desirable results.

What is claimed is:

1. An inertial sensor for determining an inertial parameter, the inertial sensor comprising:
a window circuit configured for:
receiving an input pulse stream based on the inertial parameter, and
selecting a portion of the input pulse stream;
an exclusive-or circuit configured for combining, using an exclusive-or operation, the selected portion with a reference pulse stream to produce a combined pulse stream;
a counter circuit configured for incrementing a count based on the combined pulse stream;
a scaling circuit configured for scaling the incremented count to produce an output signal corresponding to the inertial parameter.

2. The inertial sensor of claim 1, further comprising:
a resonator configured for producing the input pulse stream.

3. The inertial sensor of claim 1, wherein the window circuit is configured to receive the input pulse stream from a second inertial sensor.

4. The inertial sensor of claim 1, further comprising:
a drive sense capacitor configured for producing a drive sense capacitance proportional to a position of an oscillating mass of the resonator.

5. The inertial sensor of claim 4, further comprising:
a drive adjustment loop configured for adjusting a drive voltage based on the drive sense capacitance.

6. The inertial sensor of claim 4, wherein:
the window circuit is configured for selecting an initial time of the selected portion based on a change in the drive sense capacitance.

7. The inertial sensor of claim 6, wherein:
the selected portion excludes a pulse edge corresponding to a reversal of direction of the oscillating mass.

8. The inertial sensor of claim 4, further comprising:
an adjustment counter circuit configured for counting pulses of the selected portion to produce an amplitude adjustment signal;
a clock adjustment circuit configured for:
adjusting, based on the drive sense capacitance, a period of a clock signal, and
adjusting, based on the amplitude adjustment signal, the period of the clock signal to produce an adjusted clock signal.

9. The inertial sensor of claim 8, further comprising:
a memory configured for storing a stored pulse stream; and
a pulse generator circuit configured for adjusting the stored pulse stream based on the adjusted clock signal to produce the reference pulse stream.

10. The inertial sensor of claim 1, further comprising:
a summing circuit configured for subtracting the reference pulse stream from the selected portion to produce a polarized pulse stream; and
a sign detection circuit configured for producing a polarity signal based on the polarized pulse stream;
wherein the scaling comprises multiplying by the polarity signal.

11. The inertial sensor of claim 1, wherein the resonator further comprises:
an oscillating mass;
a capacitor configured for producing a capacitance and an extremum in the capacitance when the oscillating mass is in an aligned position;
an analog front end circuit configured for producing the input pulse stream based on the capacitance.

12. The inertial sensor of claim 11, wherein the input pulse stream is a digital signal.

13. The inertial sensor of claim 1, wherein the inertial parameter is an acceleration of the inertial sensor.

14. The inertial sensor of claim 1, wherein:
the inertial sensor is a gyroscope; and
the inertial parameter is a velocity of a vibrating mass of the gyroscope.

15. A method for determining an inertial parameter of an inertial sensor, the method comprising:
receiving, by a window circuit of the inertial sensor, an input pulse stream based on the inertial parameter;
selecting, with the window circuit, a portion of the input pulse stream;
using an exclusive-or circuit of the inertial sensor for combining, using an exclusive-or operation, the selected portion with a reference pulse stream to produce a combined pulse stream;
incrementing, with a counter circuit of the inertial sensor, a count based on the combined pulse stream;
scaling, with a scaling circuit of the inertial sensor, the incremented count to produce an output signal corresponding to the inertial parameter.

16. The method of claim 15, further comprising producing, with a resonator of the inertial sensor, the input pulse stream.

17. The method of claim 15, wherein the input pulse stream is received from a second inertial sensor.

18. The method of claim 15, further comprising:
producing, with a drive sense capacitor of the inertial sensor, a drive sense capacitance proportional to a position of an oscillating mass of the resonator.

19. The method of claim 18, further comprising:
adjusting, with a drive adjustment loop of the inertial sensor, a drive voltage based on the drive sense capacitance.

20. The method of claim 18, further comprising:
selecting, with the window circuit of the inertial sensor, an initial time of the selected portion based on a change in the drive sense capacitance.

21. The method of claim 20, wherein:
the selected portion excludes a pulse edge corresponding to a reversal of direction of the oscillating mass.

22. The method of claim 18, further comprising:
counting, with an adjustment counter circuit of the inertial sensor, pulses of the selected portion to produce an amplitude adjustment signal;
using a clock adjustment circuit of the inertial sensor for:
adjusting, based on the drive sense capacitance, a period of a clock signal, and
adjusting, based on the amplitude adjustment signal, the period of the clock signal to produce an adjusted clock signal.

23. The method of claim 22, further comprising:
storing, with a memory of the inertial sensor, a stored pulse stream; and
adjusting, with a pulse generator circuit of the inertial sensor, the stored pulse stream based on the adjusted clock signal to produce the reference pulse stream.

24. The method of claim 15, further comprising:
subtracting, with a summing circuit of the inertial sensor, the reference pulse stream from the selected portion to produce a polarized pulse stream; and
producing, with a sign detection circuit of the inertial sensor, a polarity signal based on the polarized pulse stream;
wherein the scaling comprises multiplying by the polarity signal.

25. The method of claim 15, further comprising:
producing, with a capacitor of the inertial sensor, a capacitance and an extremum in the capacitance when an oscillating mass of the inertial sensor is in an aligned position;
producing, with an analog front end circuit of the inertial sensor, the input pulse stream based on the capacitance.

26. The method of claim 25, wherein the input pulse stream is a digital signal.

27. The method of claim 15, wherein the inertial parameter is an acceleration.

28. The method of claim 15, wherein the inertial parameter is a velocity of a vibrating mass of a gyroscope.
